(19) United States
(12) Patent Application Publication
(10) Pub. No.: US 2026/0246881 A1
(43) Pub. Date: Aug. 20, 2026

(54) IMAGE FORMING APPARATUS

(71) Applicant: SHARP KABUSHIKI KAISHA, Sakai City (JP)

(72) Inventor: Mitsunori OHYA, Sakai City (JP)

(21) Appl. No.: 19/539,556

(22) Filed: Feb. 13, 2026

(30) Foreign Application Priority Data
Feb. 17, 2025 (JP) 2025-022954

(51) Int. Cl. H04N 1/12; H04N 1/00; H04N 1/193; H04N 1/32

(52) U.S. Cl. CPC H04N 1/12; H04N 1/00037; H04N 1/00344; H04N 1/00814; H04N 1/193; H04N 1/3263; H04N 2201/0081; H04N 2201/0082

(57) ABSTRACT

An image forming apparatus includes a display, a document conveyor that conveys a document, a reader that reads the document and generates document data including a plurality of pieces of line data, a dirt detector that detects dirt on the reader, based on the generated plurality of pieces of line data, and one or more controllers that cause the document conveyor to stop conveying the document when dirt on the reader is detected, and cause the display to display a page number of the document when the dirt is detected and a dirt position on the reader corresponding to the dirt detected among the generated document data.

### DESCRIPTION

### CROSS-REFERENCE TO RELATED APPLICATION

The present application claims priority from Japanese Application JP2025-22954, filed on February 17, 2025, the content of which is hereby incorporated by reference into this application.

### BACKGROUND

### 1. Field

The present disclosure relates to an image forming apparatus.

### 2. Description of the Related Art

In the related art, a technique is disclosed in which, when a reserved job is executed, it is detected whether an abnormal pixel caused by dirt at a reading position is present, based on a plurality of pieces of line data output from a document reading means. In such a technique, when an abnormal pixel is detected, a user is notified of a predetermined message, and an instruction indicating whether a document determined to have the abnormal pixel is output is input.

### SUMMARY

For example, when a document is being read by using a scanner, dirt may adhere to a reader. In such a case, it is preferable to present to the user dirt that adheres to the reader at an early stage. The related art does not solve such a problem. In view of this, an object of the present disclosure is to provide an image forming apparatus capable of presenting to a user, at an early stage, dirt that adheres to a reader.

An image forming apparatus according to an aspect of the present disclosure includes a display, a document conveyor that conveys a document, a reader that reads the document and generates document data including a plurality of pieces of line data, a dirt detector that detects dirt on the reader, based on the generated plurality of pieces of line data, and a controller that causes the document conveyor to stop conveying the document when dirt on the reader is detected, and causes the display to display a page number of the document when the dirt is detected and a dirt position on the reader corresponding to the dirt detected among the generated document data.

### BRIEF DESCRIPTION OF THE DRAWINGS

FIG. 1 is a diagram illustrating an example of a structure of an image forming apparatus.

FIG. 2 is a block diagram illustrating an example of a configuration of the image forming apparatus.

FIG. 3 is a flowchart illustrating an example of an operation of the image forming apparatus.

FIG. 4 is a flowchart illustrating an example of an operation of the image forming apparatus, following FIG. 3.

FIG. 5 is a flowchart illustrating an example of an operation of the image forming apparatus, following FIG. 4.

FIG. 6 is a flowchart illustrating an example of dirt determination processing.

FIG. 7 is a diagram illustrating an example of document data.

FIG. 8 is a diagram illustrating an example of a suspension screen displayed on a display when single-sided printing is performed.

FIG. 9 is a diagram illustrating an example of a suspension screen displayed on the display when double-sided printing is performed.

FIG. 10 is a diagram illustrating an example of a suspension screen displayed on the display when collective printing is performed.

FIG. 11 is a diagram illustrating an example of document data including abnormal data in a part thereof.

FIG. 12 is a diagram illustrating an example of a suspension screen displayed on the display when single-sided printing is performed.

FIG. 13 is a diagram illustrating an example of a suspension screen according to a first modification.

FIG. 14 is a diagram for describing processing of deleting abnormal data.

### DETAILED DESCRIPTION OF THE DISCLOSURE

### First Embodiment

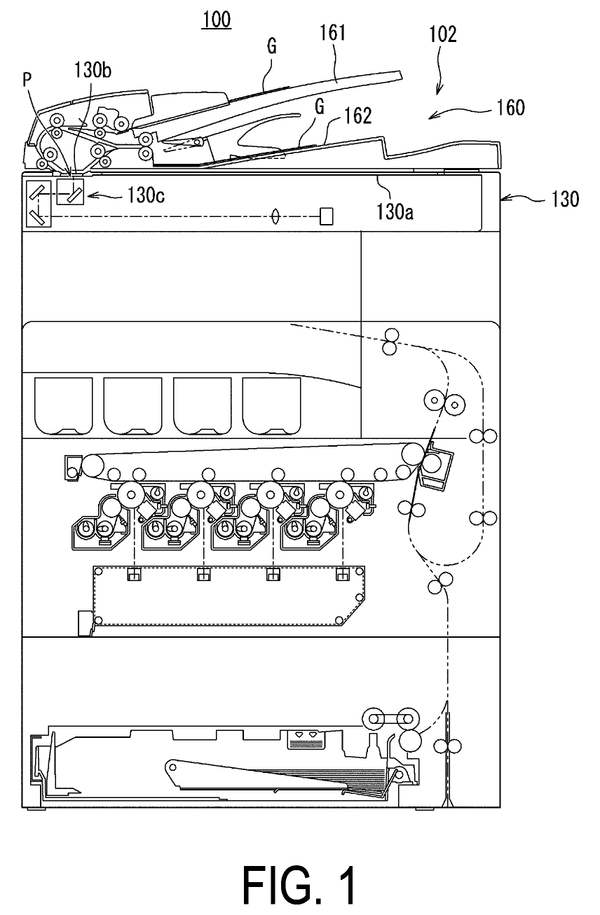

With reference to FIG. 1 to FIG. 12, a first embodiment is described. In the drawings, the same or equivalent elements are denoted by the same reference signs, and redundant descriptions are omitted.

FIG. 1 is a diagram illustrating an example of a structure of an image forming apparatus 100. The image forming apparatus 100 includes a copy function, a scanner function, and the like. The image forming apparatus 100 forms an image on a sheet, and the image is indicated by document data generated by reading a document G by an image reading device 102. Alternatively, the image forming apparatus 100 transmits document data generated by reading the document G by the image reading device 102 to a terminal device (not illustrated) connected to the image forming apparatus 100 via a network.

The image reading device 102 includes a document placement table 130a, a reader 130, and a document conveyor 160. The document placement table 130a is formed of transparent glass on which the document G is placed, and is provided to an upper part of the image reading device 102. The document conveyor 160 is provided on an upper side of the document placement table 130a.

The document conveyor 160 is arranged at an upper part of the reader 130 so as to be freely openable and closable with respect to the reader 130, and conveys the document G. The document conveyor 160 includes a document placement tray 161 and a document discharge tray 162. A user places the document G on the document placement tray 161. The document conveyor 160 conveys one page of the document G or two or more pages of the documents G placed on the document placement tray 161 one by one subsequently to a document reading position P. Further, the document G may be placed manually by opening the upper side of the document placement table 130a. The document G that is read by the reader 130 and discharged is stacked on the document discharge tray 162.

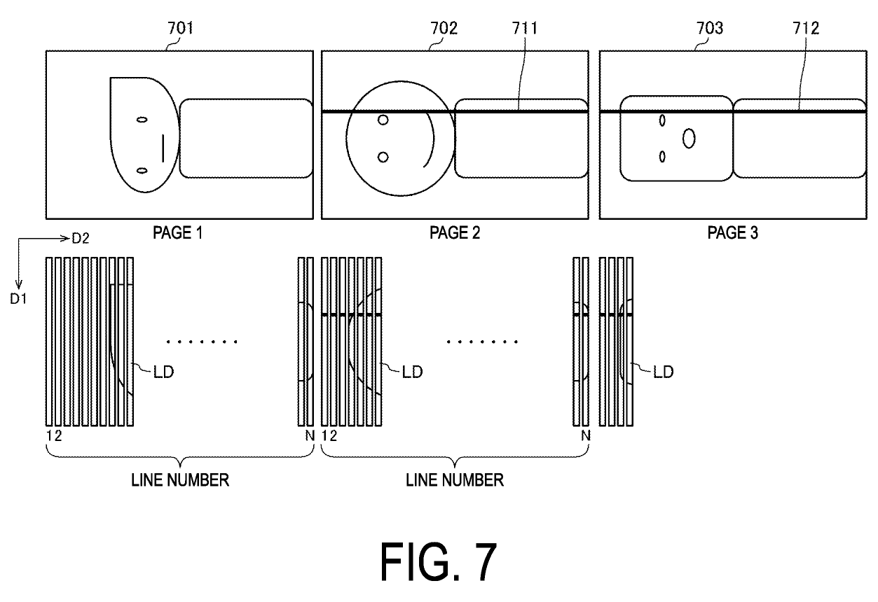

The reader 130 reads the document G, and generates document data including a plurality of pieces of line data. The reader 130 includes a document window 130b and a scanning optical system 130c including a plurality of light sources. The document window 130b is arranged at the document reading position P. The reader 130 performs scanning with the scanning optical system 130c to read the document G conveyed to the document reading position P by the document conveyor 160 for each line along a main scanning direction D1 (see FIG. 7), and generates the plurality of pieces of line data. Alternatively, the reader 130 reads the document G placed on the document placement table 130a for each line along the main scanning direction D1, and generates the plurality of pieces of line data. In this manner, the reader 130 generates the document data including the plurality of pieces of line data.

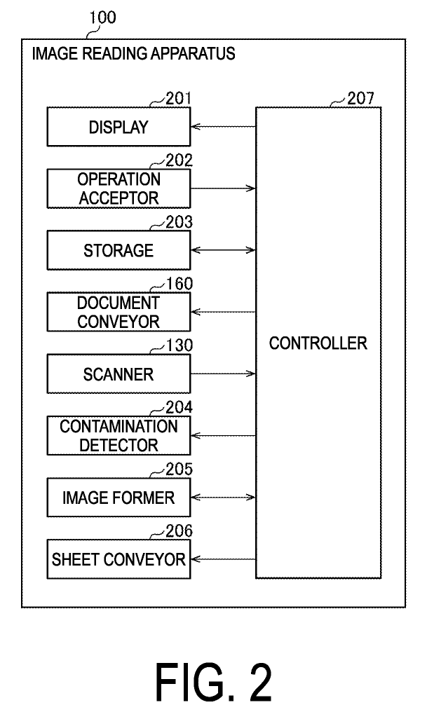

FIG. 2 is a block diagram illustrating an example of a configuration of the image forming apparatus 100. The image forming apparatus 100 includes a display 201, an operation unit 202, a storage 203, the document conveyor 160, the reader 130, a dirt detector 204, an image former 205, a sheet conveyor 206, and one or more controllers 207.

The display 201 displays information to be presented to a user. For example, the display 201 is configured by a liquid crystal panel, an organic Electro-Luminescence (EL) panel, or the like. The operation unit 202 receives an operation by a user. For example, the operation unit 202 is configured by a touch panel, or the like. Note that a touch panel display in which the operation unit 202 and the display 201 are integrated may be used.

The storage 203 is a storage medium that can store a program, various types of data, and the like. The storage 203 is configured by one or more read only memories (ROMs), one or more random access memories (RAMs), one or more hard disk drives (HDDs), or a combination thereof.

The dirt detector 204 detects dirt on the reader 130, based on the plurality of pieces of line data. The dirt detector 204 detects dirt on the reader 130 when the same abnormal candidate that is at the same position, has the same size, and has the same color in a sub-scanning direction D2 (see FIG. 7) is included in all of the plurality of pieces of line data.

The image former 205 forms an image based on the document data by causing a color material to adhere to a sheet. For example, the image former 205 is configured with a laser printer using an electrophotographic system, and forms an image on the sheet by causing toner as a color material to adhere to the sheet. Alternatively, the image former 205 may be configured by an inkjet printer using an inkjet method. When being configured by an inkjet printer, the image former 205 attaches an ink serving as a coloring material to a sheet to form an image on the sheet.

The sheet transporter 206 transports the sheet formed with the image by the image former 205 to a sheet discharge port (not illustrated).

The controller 207 executes various types of processing in accordance with the program and the data stored in the storage 203. For example, the controller 207 is configured by a control circuit formed of a processor such as one or more central processing units (CPUs).

The controller 207 causes the document conveyor 160 to stop conveying the document G when dirt on the reader 130 is detected, and causes the display 201 to display a page number of the document when the dirt is detected and a dirt position on the reader 130 corresponding to the dirt detected among the generated document data. Further, when dirt on the reader 130 is detected, the controller 207 causes the display 201 to display document data including abnormal data.

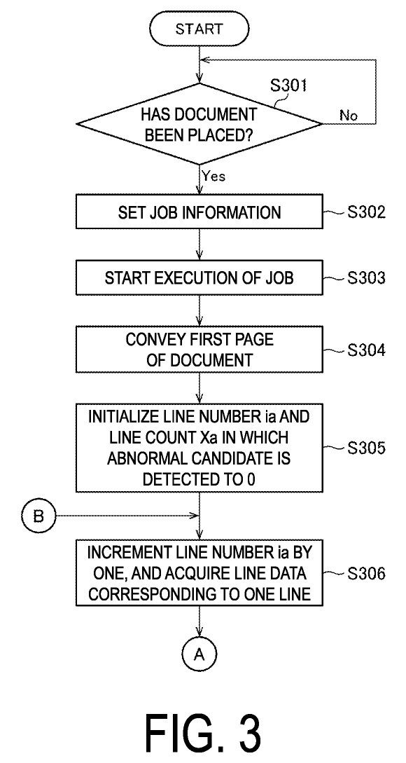

FIG. 3 is a flowchart illustrating an example of an operation of the image forming apparatus 100.

In step S301, the controller 207 determines whether the document G is placed on the document placement tray 161 or the document placement table 130a. For example, when the document G placed on the document placement tray 161 is detected, and the document G can be conveyed by the document conveyor 160, the controller 207 determines that the document G is placed.

In step S302, the controller 207 sets job information. The job information indicates setting contents indicating a copy function, a scan function, or the like. Further, the job information indicates information for setting single-sided printing, double-sided printing, or the like. For example, when the operation unit 202 receives an operation of inputting information indicated by the job information, the controller 207 sets the job information indicating the input information by the operation received by the operation unit 202.

In step S303, the controller 207 starts execution of the job, based on the job information that is set in step S302.

In step S304, the controller 207 causes the document conveyor 160 to convey, to the document reading position P, the first page of the document among one page of the document G or two or more pages of the documents G placed on the document placement tray 161. Specifically, the controller 207 causes the document conveyor 160 to convey, to the document reading position P, the first page of the document G among one page of the document G or two or more pages of the documents G placed on the document placement tray 161.

In step S305, the controller 207 initializes a line number ia and a line count Xa in which an abnormal candidate is detected to 0.

In step S306, the reader 130 increments the line number ia by one, and acquires line data LD corresponding to one line (see FIG. 7). Specifically, the reader 130 performs scanning with the scanning optical system 130c to read one line along the main scanning direction D1 in the document G conveyed to the document reading position P by the document conveyor 160, and acquires the line data LD. The reader 130 divides the document G into the line data LD corresponding to N lines in total, and reads the document G. The total line count N is a predetermined integer of 2 or more. The line data LD corresponding to the one line indicates an image obtained by reading a range of the document G along the main scanning direction D1, which corresponds to the document window 130b.

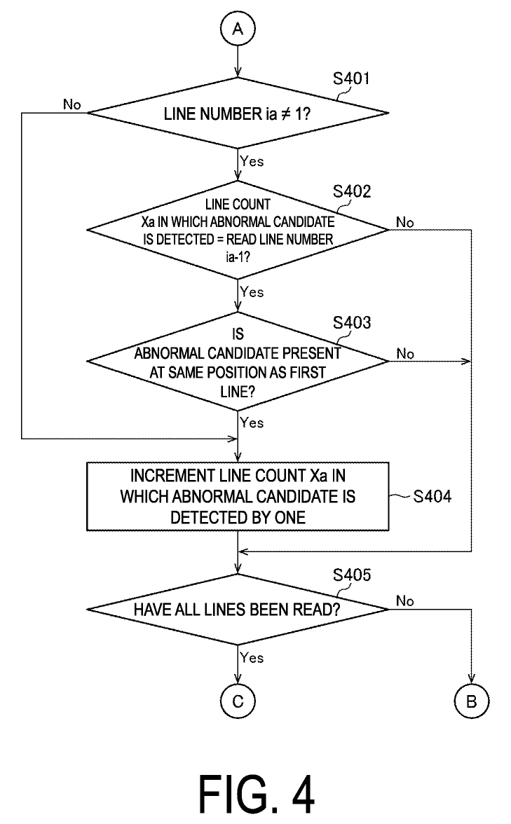

Further, the dirt detector 204 assigns the line number ia to the line data LD corresponding to each line. ia is an integer of 1 or more and N or less. In the following description, the dirt detector 204 assigns the line number ia = 1 to the line data LD that is first acquired along the sub-scanning direction D2 from the document G. Further, the reader 130 increments the line number by one sequentially toward the sub-scanning direction D2. Then, the controller 207 proceeds the processing to step S401 illustrated in FIG. 4 as an example.

FIG. 4 is a flowchart illustrating an example of an operation of the image forming apparatus 100, following FIG. 3.

In step S401, the dirt detector 204 determines whether the line number ia is 1, the line number ia being assigned to the latest line data LD acquired in step S306 illustrated in FIG. 3. In other words, the dirt detector 204 determines whether the latest line data LD that is acquired is the first line data LD.

In step S401, when the line number ia assigned to the latest line data LD is 1, the controller 207 proceeds the processing to step S405. In contrast, in step S401, when the line number ia assigned to the latest line data LD is not 1, the controller 207 proceeds the processing to step S402.

In step S402, the dirt detector 204 determines whether the line count Xa in which the abnormal candidate is detected is a read line count ia-1. When the abnormal candidate is included in all of the line data LD until the latest line data LD acquired by the reader 130 is acquired, the line count Xa in which the abnormal candidate is detected is the read line count ia-1. In contrast, when the line data LD without an abnormal candidate is present until the latest line data LD is generated, the line count Xa in which the abnormal candidate is detected is not equal to the line count ia-1.

When the line count Xa in which the abnormal candidate is detected is not the read line count ia-1 in step S402, the controller 207 proceeds to the processing to step S405. In contrast, when the line count Xa in which the abnormal candidate is detected is the read line count ia-1 in step S402, the dirt detector 204 determines whether the latest line data LD that is acquired includes the same abnormal candidate that is at the same position, has the same size, and has the same color in the first line in step S403. For example, when dirt adheres to the document window 130b, all of the line data LD that are read after adhesion of the dirt include an abnormal candidate indicating the same linear image that is at the same position in the sub-scanning direction D2, has the same size, and has the same color.

When it is not determined that the latest line data LD includes the same abnormal candidate that is at the same position, has the same size, and has the same color in the first line in step S403, the controller 207 proceeds the processing to step S405. In contrast, when it is determined that the latest line data LD that is acquired includes the same abnormal candidate that is at the same position, has the same size, and has the same color in the first line in step S403, the dirt detector 204 increments the line count Xa in which the abnormal candidate is detected by one in step S404.

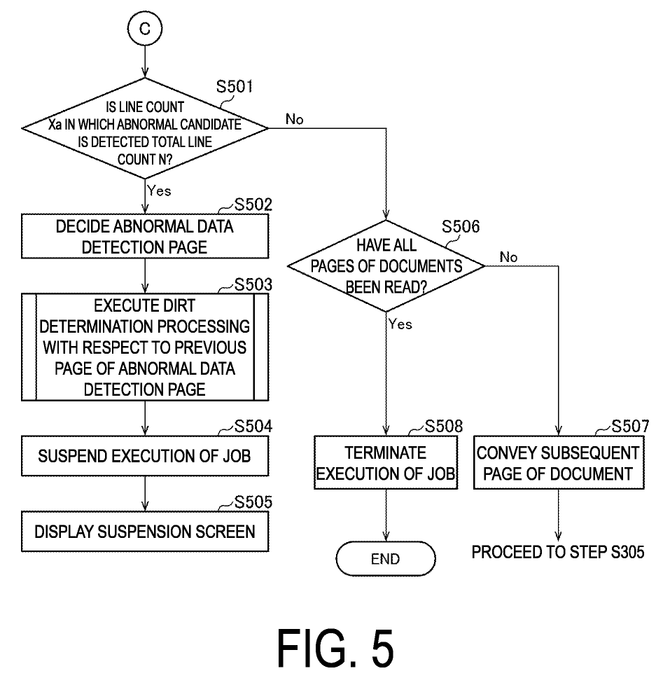

In step S405, the dirt detector 204 determines whether all of the line data LD is read. In other words, the dirt detector 204 determines whether the document G, which is conveyed to the document reading position P in step S304 illustrated in FIG. 3 or step S506 illustrated in FIG. 5, has been read completely. When the read line count ia reaches the total line count N, the controller 207 determines that all of the lines have been read. In contrast, when the read line count ia does not reach the predetermined total line count N, the controller 207 determines that all of the lines have not been read.

When it is determined that all of the lines have not been read in step S405, the controller 207 returns the processing to step S306 illustrated in FIG. 3. In contrast, it is determined that all of the lines have been read in step S405, the controller 207 proceeds the processing to step S501 illustrated in FIG. 5.

FIG. 5 is a flowchart illustrating an example of an operation of the image forming apparatus 100, following FIG. 4.

In step S501, the dirt detector 204 determines whether the line count Xa in which the abnormal candidate is detected is the total line count N. When the line count Xa in which the abnormal candidate is detected is the total line count N in step S501, the dirt detector 204 detects the dirt on the reader 130, and decides, as an abnormal data detection page, a page where the line count Xa in which the abnormal candidate is detected is the total line count N in step S502.

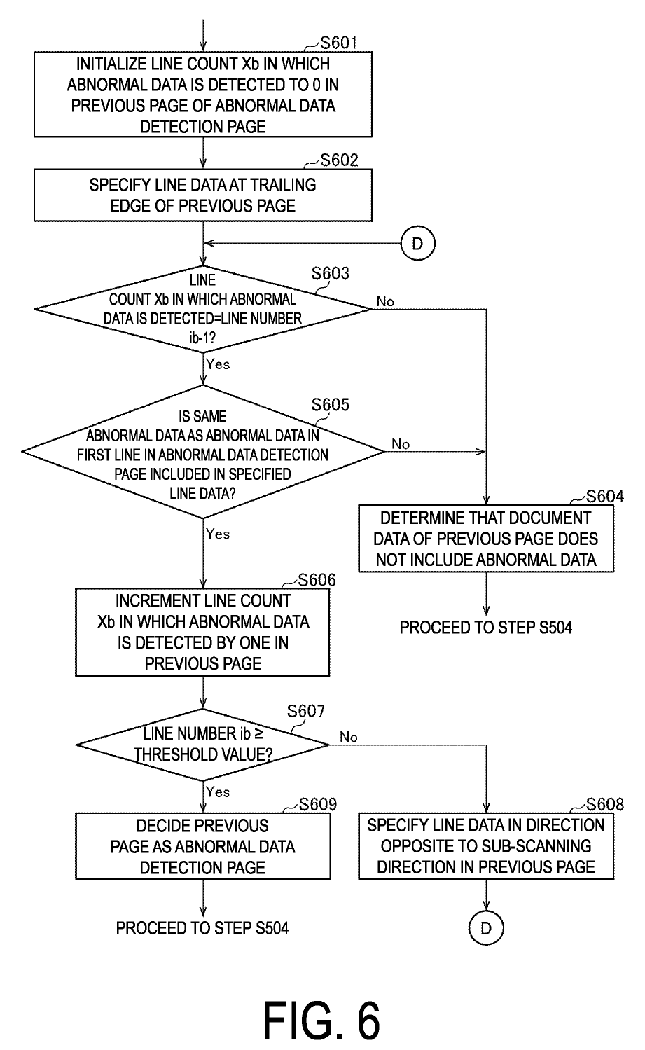

In step S503, the dirt detector 204 executes dirt determination processing for a previous page of the abnormal data detection page. Details of the dirt determination processing in the previous page of the abnormal data detection page are described later with reference to FIG. 6.

In step S504, the controller 207 suspends execution of the job. Specifically, the controller 207 causes the document conveyor 160 to stop conveying the document G. Further, the controller 207 stops execution of the processing of outputting the document data. For example, when the job indicates execution of the copy function, the controller 207 causes the image former 205 to stop forming an image on a sheet based on the document data. Further, for example, when the job indicates execution of the scan function, the controller 207 stops the processing of outputting the document data based on one page of the document G or two or more pages of the documents G read by the reader 130. When there is dirt on the reader 130, the image forming apparatus 100 may continue forming the document data including the abnormal data. However, when the dirt on the reader 130 is detected, the image forming apparatus 100 suspends execution of the job, and avoids continuing generation of the document data including the abnormal data.

In step S505, the controller 207 causes the display 201 to display a suspension screen.

In contrast, when the number of lines in which an abnormal candidate is detected is not the total line count N in step S501, the controller 207 executes the processing of outputting the document data, and proceeds the processing to step S506. For example, when the job indicates execution of the copy function, the processing of outputting the document data is processing of causing the image former 205 to form an image on a sheet based on the document data. For example, when the job indicates execution of the scan function, the processing out outputting the document data is processing of causing the storage 203 to store the document data based on the document G read by the reader 130.

In step S506, the controller 207 determines whether all of the pages have been read. For example, when the document conveyor 160 conveys the document G from the document placement tray 161, the controller 207 determines that all of the pages have not been read. In contrast, for example, when the document conveyor 160 conveys all of the documents G placed on the document placement tray 161, and the document conveyor 160 does no longer convey the document G from the document placement tray 161, the controller 207 determines that all of the pages have been read.

When it is determined that all of the pages have not been read in step S506, the controller 207 causes the document conveyor 160 to convey, to the document reading position P, the subsequent page of the document G among one page of the document G or two or more pages of the documents G placed on the document placement tray 161 in step S507. Then, the controller 207 returns the processing to step S305 illustrated in FIG. 3. In contrast, when it is determined that all of the pages have been read in step S506, the controller 207 terminates execution of the job in step S508.

FIG. 6 is a flowchart illustrating an example of the dirt determination processing executed in step S503 of FIG. 5.

In step S601, the dirt detector 204 sets a line count Xb in which the abnormal data is detected to 0 in the previous page of the abnormal data detection page.

In step S602, the dirt detector 204 specifies the line data LD at the trailing edge of the previous page of the abnormal data detection page. The line data LD at the trailing edge is the line data LD that is read at the N-th time. The dirt detector 204 assigns the line number ib, which is 1, to the line data LD at the trailing edge in the dirt determination processing in the previous page of the abnormal data detection page. In other words, the dirt detector 204 assigns the line number, which is 1, to the line data LD that is read at the N-th time. Note that, in dirt detection processing in the previous page of the abnormal data detection page, the line number ib assigned to the line data LD is incremented by one in an order reverse to the order in which reading is executed.

In step S603, the dirt detector 204 determines whether the line count Xb in which the abnormal data is detected is a line number ib-1 in the previous page of the abnormal data detection page. In other words, when the dirt detector 204 determines whether the abnormal data is included sequentially from the line data LD at the trailing edge of the previous page of the abnormal data detection page, the dirt detector 204 determines that the line count Xb in which the abnormal data is detected is the line number ib-1 in the previous page of the abnormal data detection page when the abnormal data is included in all of the line data LD determined up to the latest. In contrast, when the dirt detector 204 determines whether the abnormal data is included sequentially from the line data LD at the trailing edge of the previous page of the abnormal data detection page, the dirt detector 204 determines that the line count Xb in which the abnormal data is detected is not the line number ib-1 in the previous page of the abnormal data detection page when the abnormal data is not included in all of the line data LD determined up to the latest.

When the line count Xb in which the abnormal data is detected is not the line number ib-1 in the previous page of the abnormal data detection page in step S603, the dirt detector 204 determines that the document data of the previous page of the abnormal data detection page does not include the abnormal data in step S604. Further, the controller 207 terminates the dirt determination processing in the previous page of the abnormal data detection page.

In contrast, when the line count Xb in which the abnormal data is detected is the line number ib-1 in the previous page of the abnormal data detection page in step S603, the dirt detector 204 determines whether the line data LD specified in step S602 includes the same abnormal data as that of the first line in the abnormal data detection page in step S605.

When the line data LD specified in step S602 does not include the same abnormal data that is at the same position, has the same size, and has the same color in the first line in the abnormal data detection page is not included in step S605, the controller 207 proceeds the processing to step S604. In other words, when the line data LD specified in step S602 does not include the same abnormal data as the abnormal data in the first line in the abnormal data detection page, the dirt detector 204 determines that the document data of the previous page of the abnormal data detection page does not include the abnormal data. Then, the controller 207 terminates execution of the dirt determination processing in the previous page of the abnormal data detection page.

In contrast, when the line data LD specified in step S602 includes the same abnormal data that is at the same position, has the same size, and has the same color in the first line in the abnormal data detection page in step S605, the dirt detector 204 increments the line count Xb in which the abnormal data is detected by one in step S606 while regarding, as Xb+1, the line count Xb in which the abnormal data is detected in the previous page of the abnormal data detection page.

In step S607, the dirt detector 204 determines whether the line number ib is equal to or greater than a threshold value. In other words, the dirt detector 204 determines whether the number of the pieces of line data LD equal to or greater than the threshold is specified in the previous page of the abnormal-data detection page.

When it is determined that the line number ib is less than the threshold value in step S607, the dirt detector 204 specifies the line data LD in a direction opposite to the sub-scanning direction D2 in the previous page of the abnormal data detection page in step S608. Then, the dirt detector 204 assigns a line number, which is ib = ib + 1, to the line data LD specified in step S608. Then, the controller 207 returns the processing to step S603.

In contrast, when it is determined that the line number ib is equal to or greater than the threshold value in step S607, the dirt detector 204 decides the previous page of the abnormal data detection page as the abnormal data detection page in step S609. In other words, when a position of the abnormal data in the sub-scanning direction D2 of the document G when the dirt on the reader 130 is detected is the same as a position of the abnormal data in a sub-scanning direction of a previous-page document being a page immediately prior to the document when the dirt is detected, the controller 207 decides a the page number of the previous page document as the page number of the document G when the dirt is detected. In view of this, when the scan function is executed, the controller 207 stores document data of an M-th page until it is determined that the document data generated by reading a document being an M+1-th page by the reader 130 does not include the abnormal data. Then, the controller 207 terminates execution of the dirt determination processing in the previous page of the abnormal data detection page.

Next, with reference to FIG. 7, the document data including the abnormal data is described. FIG. 7 illustrates an example of the document data including the abnormal data when the reader 130 reads documents from a first page to a third page.

The document data 701 is document data acquired by reading the first page of the documents G by the reader 130. The document data 702 is document data acquired by reading the second page of the documents G by the reader 130. The document data 703 is document data acquired by reading the third page of the documents G by the reader 130.

The document data 702 includes abnormal data 711. Abnormal data 712 is the same as the abnormal data 711. Specifically, the abnormal data 711 extends from one end to the other end along the sub-scanning direction D2 in the document data 702. In other words, all of the line data LD included in the document data 702 includes the abnormal data. Further, the document data 703 also includes the abnormal data 712. The abnormal data 712 extends from one end to the other end along the sub-scanning direction D2 in the document data 703. In other words, all of the line data LD included in the document data 703 includes the abnormal data.

Further, in an image indicated by the document data 703, a liner image indicated by the abnormal data 712 is included at the same position of a linear image indicated by the abnormal data 711. All of the plurality of pieces of line data LD included in the document data 703 includes the same abnormal data that is at the same position, has the same size, and has the same color as the abnormal data included in the line data LD included in the document data 702.

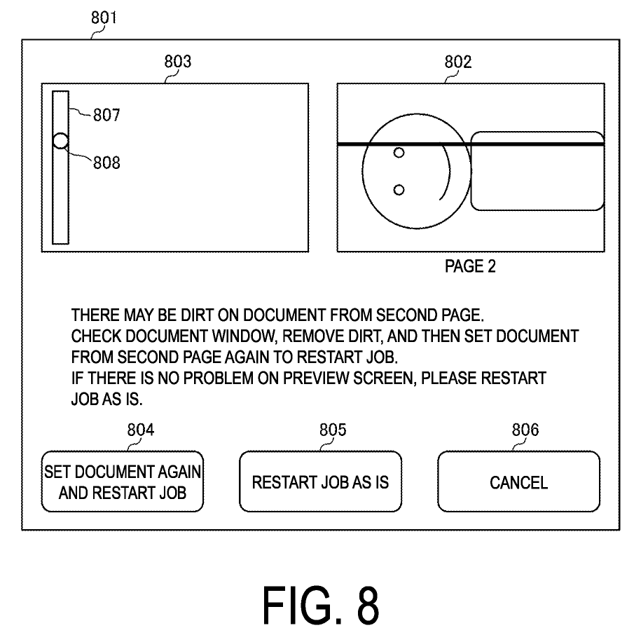

FIG. 8 is a diagram illustrating an example of a suspension screen 801 displayed on the display 201 when single-sided printing is performed. The suspension screen 801 includes an image 802, an image 803, and a button 804 “Set the document again, and restart the job”, a button 805 “Restart the job as is”, and a cancel button 806.

The image 802 shows the document data 702 illustrated in FIG. 7. The suspension screen 801 includes the image 802. With this, the image forming apparatus 100 can first present to a user the image showing the document data 702 including the abnormal data 711.

The image 803 includes a region 807 that schematically indicates the document window 130b. The region 807 includes dirt position presentation information 808. The dirt position presentation information 808 indicates the dirt position on the reader 130 that causes the abnormal data 711 and the abnormal data 712. When the dirt position on the reader 130 is not presented, a user may not understand the cause of the abnormal data included in the document data. As a result, the image forming apparatus 100 may generate the document data including the abnormal data, and may repeatedly output the document data. However, when the suspension screen 801 includes the image 803, the image forming apparatus 100 can allow a user to recognize the dirt position on the reader 130. With this, the image forming apparatus 100 prompts a user to clean the document window 130b by presenting the dirt position on the reader 130, and the user can easily clean the document window 130b.

Further, the controller 207 executes processing of causing a light source at the dirt position among the plurality of light sources included in the scanning optical system 130c to turn on or to flash. With this, the image forming apparatus 100 can allow a user to recognize the dirt position on the reader 130, and prompt the user to remove the dirt from the document window 130b.

Further, the suspension screen 801 shows a message “There may be dirt on the document from the second page. Check the document window, remove the dirt, and then set the document from the second page again to restart the job”. In other words, the controller 207 causes the display 201 to display the page number of the document G when the dirt on the reader 130 is detected. With this, the image forming apparatus 100 prompts a user to clean the document window 130b to remove the dirt causing the abnormal data 711 and the abnormal data 712, and restarts execution of the job from the page of the document G when the dirt is detected to start rereading.

Further, the suspension screen 801 includes a message “If there is no problem on the preview screen, please restart the job as is”. With this, the image forming apparatus 100 can cause a user to recognize that the user can select whether to restart execution of the job.

When the job indicates execution of the copy function, and the operation unit 202 receives an operation of selecting the button 804 “Set the document again, and restart the job”, the controller 207 terminates a suspended state of execution of the job, and restarts the job with respect to the document G subsequent to the abnormal data detection page. For example, in the present example, the abnormal data detection page corresponds to the second pate, and hence the controller 207 restarts execution of the job, and restarts rereading with respect to the document G from the second page onward. The document data 702 and 703 including the abnormal data 711 and 712 are not results intended by a user. However, the controller 207 causes the reader 130 to execute the rereading processing from the document G corresponding to the page when the dirt is detected. With this, the image forming apparatus 100 can avoid wasteful output.

When the job indicates execution of the scan function, and the operation unit 202 receives an operation of selecting the button 804 “Set the document again, and restart the job”, the controller 207 terminates a suspended state of execution of the job, and executes the processing of deleting the document data based on the document G subsequent to the abnormal data detection page from the storage 203.

For example, it is assumed that the storage 203 stores the document data 701 to the document data 703. In such a case, in the present example, the abnormal data detection page corresponds to the second page, and hence the controller 207 executes the processing of deleting the document data 702 and the document data 703 from the storage 203. Then, the controller 207 restarts execution of the job with respect to the document G subsequent to the abnormal data detection page. In other words, the controller 207 restarts execution of the job with respect to the document G from the second page onward. Note that, before the operation unit 202 receives an operation of selecting the button 804 “Set the document again, and restart the job”, a user is assumed to place the document G subsequent to the abnormal data detection page, among all of the documents G discharged to the document discharge tray 162, on the document placement tray 161 again.

Further, when the operation unit 202 receives an operation of selecting the button 805 “Restart the job as is”, the controller 207 terminates a suspended state of execution of the job, and restarts execution of the job. In such a case, a user does not place the document G discharged to the document discharge tray 162 on the document placement tray 161 again, and the operation unit 202 receives an operation of selecting the button 805 “Restart the job as is”. Further, the operation unit 202 receives an operation of selecting the cancel button 806, the controller 207 terminates execution of the job.

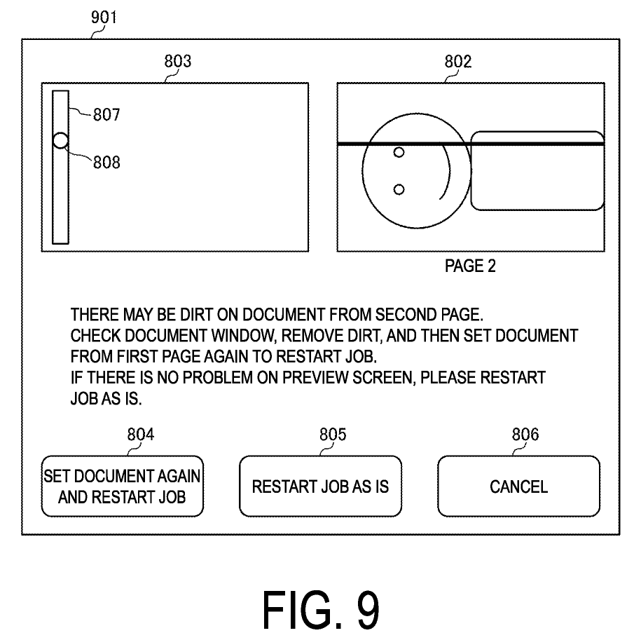

FIG. 9 is a diagram illustrating an example of a suspension screen 901 displayed on the display 201 when double-sided printing is performed. For example, during double-sided printing, when one page is printed on each surface of a sheet, an odd-numbered page and an even-numbered page are printed on the same sheet. Thus, an image based on the document data not including the abnormal data and an image of the document data including the abnormal data are printed on the same sheet.

Then, the suspension screen 901 shows a message “There may be dirt on the document from the second page. Check the document window, remove the dirt, and then set the document from the first page again to restart the job”. With this, the image forming apparatus 100 can prompt a user to remove the dirt causing the abnormal data 711 and the abnormal data 712, and can also prompt a user to restart execution of the job and start rereading with respect to a page corresponding to an image shown on a sheet on which the document data including the abnormal data 711 is printed.

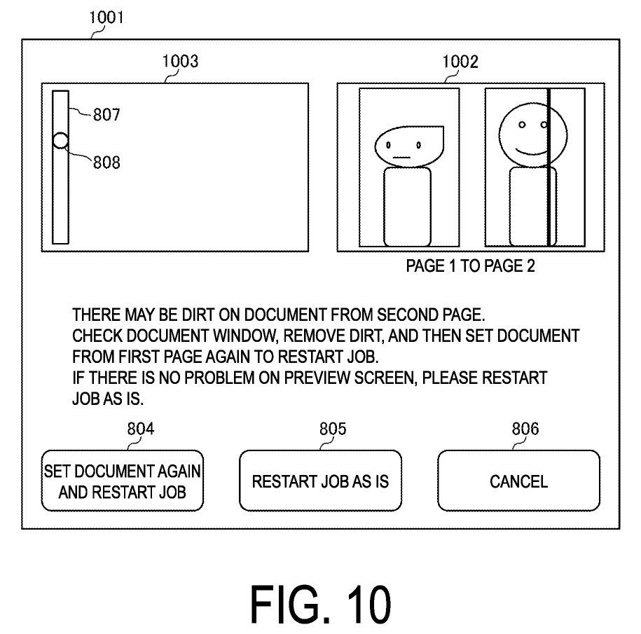

FIG. 10 is a diagram illustrating an example of a suspension screen 1001 displayed on the display 201 when collective printing is set. In the present disclosure, the collective printing setting refers to printing of a plurality of pages collectively on one surface of a sheet.

The suspension screen 1001 includes collective document data 1002. The controller 207 causes the display 201 to display collective document data obtained by collectively combining the document data of each of the plurality of documents G subjected to rereading.

For example, when two pages are printed on each surface of a sheet, an image based on the document data not including the abnormal data and an image based on the document data including the abnormal data are printed on the same surface of the sheet. Note that the suspension screen 1001 shows a case in which two pages are printed on each surface of a sheet, but this is only an example and is not intended to be limited to printing two pages on each surface of a sheet. For example, when four pages are printed on each surface of a sheet, an image based on the document data not including the abnormal data, an image based on the document data including the abnormal data, and an image based on the document data including the abnormal data are printed on the same surface of the sheet.

Further, the suspension screen 1001 shows a message “There may be dirt on the document from the second page. Check the document window, remove the dirt, and then set the document from the first page again to restart the job”. In other words, when the collective printing setting in which the plurality of documents G are collectively printed is set, and the dirt on the reader 130 is detected in any one of the plurality of documents G, the controller 207 presents information for starting rereading from a document of a first page in the collective printing setting. With this, the image forming apparatus 100 can prompt a user to clean the document window 130b to remove the dirt causing the abnormal data, and can also prompt the user to reprint from a sheet on which the document data including the abnormal data is printed.

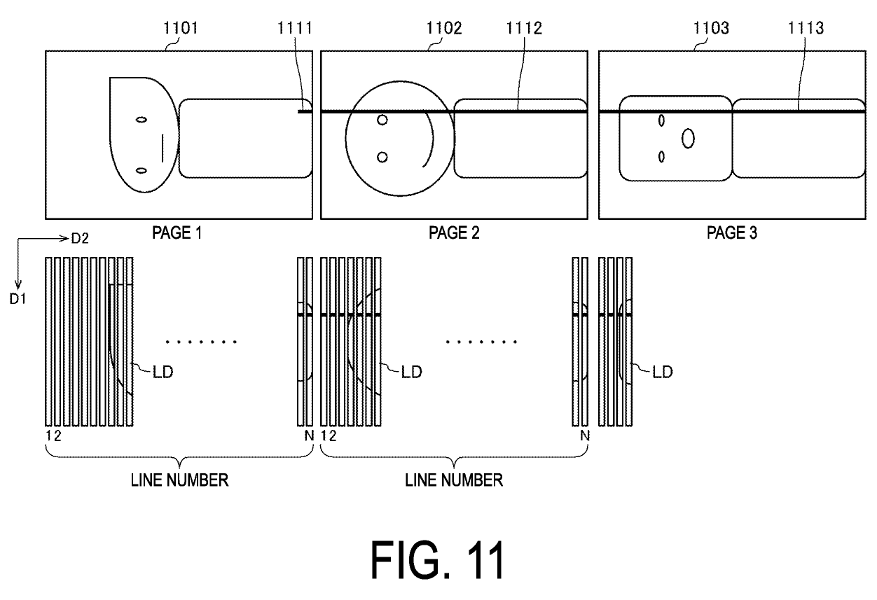

FIG. 11 illustrates an example of document data including abnormal data in a part thereof when the reader 130 reads documents from a first page to a third page. Document data 1101 to the document data 1103 are different from the document data 701 to the document data 703 illustrated in FIG. 7 in that the document data 1101 includes abnormal data 1111.

When dirt adheres to the document window 130b while the reader 130 reads the first page of the documents G, the line data LD included in the document data 1101 corresponding to the first page of the documents G includes the abnormal data 1111. All of the line data LD included in the document data 1101 does not include the abnormal data. Thus, in step S502 illustrated in FIG. 5, the dirt detector 204 does not decide the first page of the documents G as the abnormal data detection page. In contrast, all of the line data LD included in the document data 1102 include the same abnormal data that is at the same position, has the same size, and has the same color in the sub-scanning direction D2. Thus, in step S502, the dirt detector 204 decides that the second page of the documents G is the abnormal data detection page. Then, in step S503 illustrated in FIG. 5, the dirt detector 204 executes the dirt determination processing for the first page corresponding to the previous page of the abnormal data detection page. Further, in step S609 illustrated in FIG. 6, the dirt detector 204 decides the first page of the documents G as the abnormal data detection page.

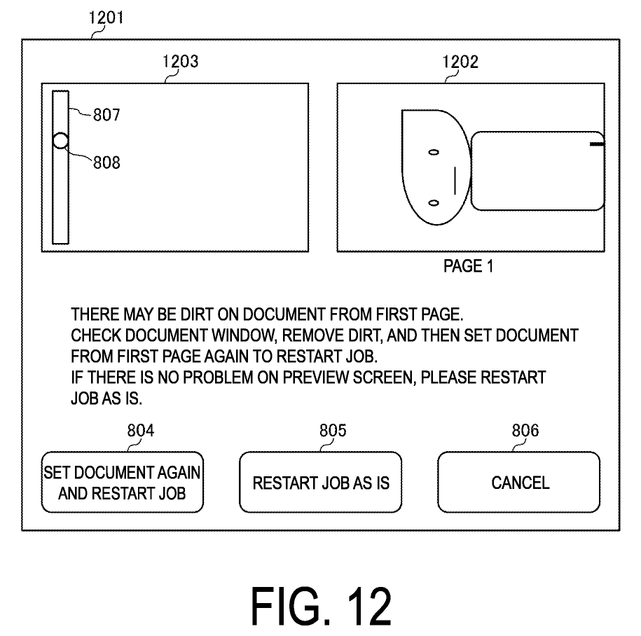

FIG. 12 is a diagram illustrating an example of a suspension screen 1201 displayed on the display 201 when single-sided printing is performed. The pause screen 1201 includes an image 1202 and an image 1203. The image 1203 is similar to that denoted with 803 illustrated in FIG. 8, and hence detailed description thereof is omitted.

The image 1202 shows the document data 1101 illustrated in FIG. 11. In other words, the image 1202 shows the document data corresponding to the page, which is the first page, where the abnormal data is detected. The suspension screen 1201 includes the image 1202. With this, the image forming apparatus 100 can present to a user the image showing the document data 1101 including the abnormal data 1111.

Further, the suspension screen 1201 shows a message “There may be dirt on the document from the first page. Check the document window, remove the dirt, and then set the document from the first page again to restart the job”. With this, the image forming apparatus 100 can prompt a user to remove the dirt causing the abnormal data 1111 to the abnormal data 1113, and can also prompt the user to restart execution of the job from the document G corresponding to the document data 1101 including the abnormal data 1111 to start rereading.

When the job indicates execution of the copy function, and the operation unit 202 receives an operation of selecting the button 804 “Set the document again, and restart the job”, the controller 207 terminates a suspended state of execution of the job, and restarts execution of the job with respect to the document G subsequent to the previous page of the abnormal data detection page. For example, in the present example, the abnormal data detection page corresponds to the second page of the documents G, and hence, the controller 207 restarts execution of the job, and starts rereading with respect to the document G from the first page onward.

When the job indicates execution of the scan function, and the operation unit 202 receives an operation of selecting the button 804 “Set the document again, and restart the job”, the controller 207 terminates a suspended state of execution of the job, and executes the processing of deleting the document data based on the document G subsequent to the previous page of the abnormal data detection page from the storage 203. For example, it is assumed that the storage 203 stores the document data 701 to the document data 703. In such a case, in the present example, the abnormal data detection page is the first page of the documents G, and hence the controller 207 executes the processing of deleting the document data 701 to the document data 703 from the storage 203. Then, the controller 207 restarts execution of the job from the document G, which is the previous page of the abnormal data detection page. For example, in the present example, the controller 207 restarts the job from the first page of the documents G.

With this, the image forming apparatus 100 according to the present embodiment can present to a user, at an early stage, the dirt that adheres to the reader 130.

### First Modification

In a first modification according to the present embodiment, the image forming apparatus 100 may feed pages prior to the abnormal data detection page of the document without reading them after prompting a user to place all the documents on the document placement tray 161 again, and may restart execution of the job with respect to the document G subsequent to the abnormal data detection page.

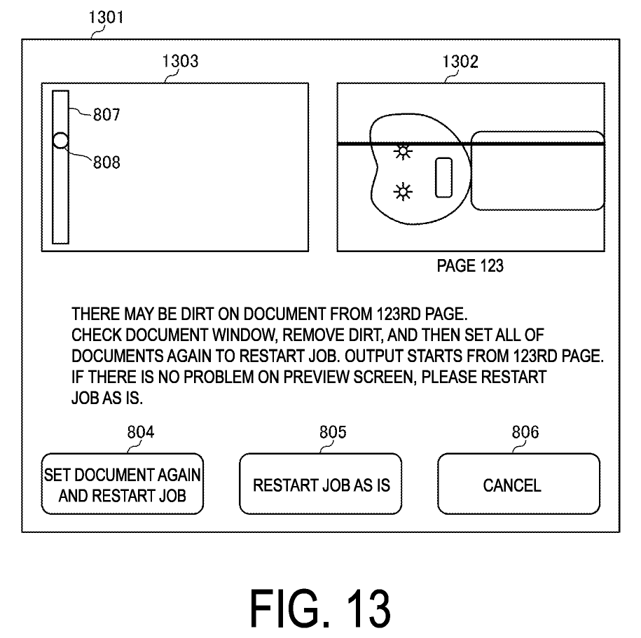

FIG. 13 is a diagram illustrating an example of a suspension screen 1301 according to the present modification.

The suspension screen 1301 includes an image 1302, an image 1303, the button 804 “Set the document again, and restart the job”, the button 805 “Restart the job as is”, and the cancel button 806. The image 1302 shows document data based on the 123rd page of the documents G. The image 1302 shows abnormal data included in the document data based on the 123rd page of the documents G. The image 1303, the button 804 “Set the document again, and restart the job”, the button 805 “Restart the job as is”, and the cancel button 806 are similar to the image 803, the button 804 “Set the document again, and restart the job”, the button 805 “Restart the job as is”, and the cancel button 806 illustrated in FIG. 8, and hence detailed description thereof is omitted.

When the dirt detector 204 detects the abnormal data from the document data, based on the 123rd page of the documents G, the documents corresponding to the first page to the 123rd page and the document G from the 123rd page onward may be discharged to the document discharge tray 162. In such a case, it may be burdensome for a user to search for the 123rd page of the documents G from the plurality of documents G discharged to the document discharge tray 162 and reset the document G. Then, as exemplified in the suspension screen 1301, the suspension screen 1301 shows a message “There may be dirt on the document from the 123rd page. Check the document window, remove the dirt, and then set the document from the first page again to restart the job. The output starts from the 123rd page”. With this, the image forming apparatus 100 according to the present modification prompts a user to place all of the documents G again without causing a user to search for the document G corresponding to the abnormal-data detection page from the plurality of documents G discharged to the document discharge tray 162. With this, the image forming apparatus 100 according to the present modification can improve user convenience.

When the operation unit 202 receives an operation of selecting the button 804 “Set the document again, and restart the job”, the controller 207 causes the document conveyor 160 to convey the documents G of the pages prior to the page subjected to the rereading processing without causing the reader 130 to reading it. For example, when the suspension screen 1301 illustrated in FIG. 13 is displayed on the display 201, the controller 207 execute the processing of causing the document conveyor 160 to convey the documents G from the first page to the 122nd page without causing the reader 130 to read them. In other words, when execution of the job is restarted after the dirt on the reader 130 is detected, the controller 207 causes the document conveyor 160 to convey the document of the page prior to the page subjected to the rereading processing without causing the reader 130 to read it. Then, the controller 207 causes the reader 130 to read the document G from the 123rd page onward. With this, the image forming apparatus 100 according to the present modification causes all of the documents G to be placed on the document placement tray 161 again after restarting execution of the job. With this, user convenience can be increased, and power consumption can be reduced by not rereading all of the documents G.

### Second Modification

In a second modification according to the present embodiment, the image forming apparatus 100 may restart execution of the job while holding the job information after a user is prompted to place all of the documents on the document placement tray 161 again.

For example, when the job indicates execution of the scan function, and the operation unit 202 receives an operation of selecting the button 804 “Set the document again, and restart the job” illustrated in FIG. 13, the controller 207 according to the present modification terminates a suspended state of execution of the job, retains the job information, and executes the processing the document data based on the document G subsequent to the abnormal data detection page from the storage 203. Then, the controller 207 executes the processing of causing the reader 130 to subsequently read the documents G of all the pages. In other words, when the dirt on the reader 130 is detected, the controller 207 retains a setting relating to the job, and restart execution of the job. With this, the image forming apparatus 100 according to the present modification causes all of the documents G to be placed on the document placement tray 161 again after restarting execution of the job without causing a user to perform an operation of inputting the information indicated by the job information again. With this, user convenience can be improved, and the job can be executed more efficiently as compared to a case in which the job information is reset.

### Third Modification

In a third modification according to the present embodiment, the image forming apparatus 100 may delete the abnormal data from the document data.

The controller 207 according to the present modification executes the processing of deleting the abnormal data from each of the plurality of pieces of line data LD, and does not execute the processing for when the dirt on the reader 130 is detected. Specifically, the controller 207 determines whether the abnormal data can be deleted based on at least one of a position and a range of the abnormal data. Then, when it is determined that the abnormal data can be deleted, the controller 207 executes the processing of deleting the abnormal data from each of the plurality of pieces of line data LD. Then, the controller 207 does not cause the document conveyor 160 to stop conveying the document G, and does not cause the display 201 to display the suspension screen.

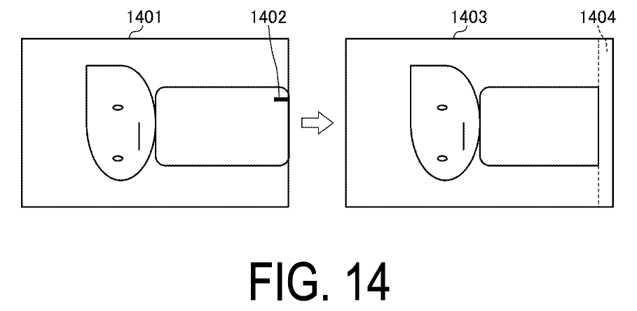

FIG. 14 is a diagram for describing the processing of deleting the abnormal data.

Document data 1401 is an example of document data including abnormal data 1402. Document data 1403 is an example of document data obtained by deleting the abnormal data 1402.

For example, the controller 207 deletes the abnormal data 1402 from the document data by masking a region including the abnormal data 1402. For example, for example, in the document data 1403, a region 1404 including the abnormal data is masked in white. With this, the image based on the document data 1403 does not include a linear image indicated by the abnormal data 1402. In other words, the image forming apparatus 100 according to the present modification outputs the document data not including the abnormal data in accordance with at least one of the position and the range of the abnormal data. With this, the image forming apparatus 100 according to the present modification can continue execution of the job even when the abnormal data is detected.

Further, after the abnormal data is deleted from each of the plurality of pieces of line data LD, the controller 207 may provide information indicating that the dirt on the reader 130 is detected through notification. For example, the controller 207 may provide information indicating that the dirt on the reader 130 is detected through notification, by causing the display 201 to display a message “There may be dirt on the document window”. With this, the image forming apparatus 100 according to the present embodiment can cause a user to recognize the dirt on the reader 130 even when the document data without the abnormal data is output.

Each of the processes executed in the embodiments described above is not limited to the processing aspect exemplified in each of the embodiments. The functional blocks described above may be each achieved by using a logic circuit (hardware) formed in an integrated circuit or the like, or by using software using a CPU. Each process described in the embodiments described above may be executed by a plurality of computers. For example, the processing executed by the image forming apparatus 100 may be executed so that a portion of the processing is executed by another computer, or may be configured so that the entire processing is executed by a plurality of computers in a distributed manner.

The disclosure is not limited to the embodiments described above, and may be replaced with a configuration that is substantially the same as the configuration illustrated in the embodiments described above, a configuration that achieves the same operations and effects, or a configuration that can achieve the same object. As for the disclosure, an embodiment obtained by appropriately combining technical means disclosed in the different embodiments is also included in the technical scope of the disclosure. Furthermore, by combining technical means disclosed in the individual embodiments, it is possible to form a new technical feature.

What is claimed is:

1. An image forming apparatus comprising:
a display;
a document conveyor that conveys a document;
a reader that reads the document and generates document data including a plurality of pieces of line data;
a dirt detector that detects dirt on the reader, based on the generated plurality of pieces of line data; and
one or more controllers that cause the document conveyor to stop conveying the document when dirt on the reader is detected, and cause the display to display a page number of the document when the dirt is detected and a dirt position on the reader corresponding to the dirt detected among the generated document data.

2. The image forming apparatus according to claim 1, wherein
the dirt detector detects the dirt when the same abnormal data that is at the same position, has the same size, and has the same color in a sub-scanning direction is included in all of the plurality of pieces of line data.

3. The image forming apparatus according to claim 2, wherein
when a position of the abnormal data in the sub-scanning direction of the document when the dirt is detected is the same as a position of the abnormal data in a sub-scanning direction of a previous-page document being a page immediately preceding the document, the controller decides a page number of the previous-page document as the page number of the document when the dirt is detected.

4. The image forming apparatus according to claim 1, wherein
when the dirt is detected, the controller causes the display to display the document data including abnormal data.

5. The image forming apparatus according to claim 1, wherein
when a collective printing setting in which a plurality of documents are collectively printed is set and the dirt is detected in any one of the plurality of documents, the controller presents information for starting rereading from a document of a first page in the collective printing setting.

6. The image forming apparatus according to claim 5, wherein
the controller causes the display to display collective document data obtained by collectively combining respective document data of the plurality of documents subjected to the rereading.

7. The image forming apparatus according to claim 1, wherein
the reader includes a plurality of light sources, and
the controller executes processing of causing a light source at the dirt position among the plurality of light sources to turn on or to flash.

8. The image forming apparatus according to claim 1, wherein
when a job is restarted after dirt on the reader is detected, the controller causes the document conveyor to convey a document of a page prior to a page subjected to the rereading processing without causing the reader to read the document.

9. The image forming apparatus according to claim 1, wherein
when the dirt is detected, the controller retains a setting relating to a job, and restarts execution of the job.

10. The image forming apparatus according to claim 1, wherein
the controller executes processing of deleting the abnormal data from each of the plurality of pieces of line data, and does not execute processing for when the dirt is detected.

11. The image forming apparatus according to claim 10, wherein
after the abnormal data is deleted from the plurality of pieces of line data, the controller provides information indicating that the dirt is detected through notification.
